(19) United States
(12) Patent Application Publication
(10) Pub. No.: US 2007/0264383 A1
(43) Pub. Date: Nov. 15, 2007

(54) Mold-cooling device having vortex-inducing cooling-fluid chamber

(75) Inventors: Joachim Johannes Niewels, Thornton (CA); Robin Wade Lovell, Oakville (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/432,627

(22) Filed: May 12, 2006

(51) Int. Cl. B29C 35/16; B29C 49/00

(52) U.S. Cl. 425/526; 425/547

(57) ABSTRACT

Disclosed, amongst other things, is: (i) a mold-cooling device; (ii) a molding system having a mold-cooling device; (iii) a mold assembly having a mold-cooling device, (iv) a molded article, such as a preform, manufactured by a molding system having a mold-cooling device; and (v) a method of a mold-cooling device.

### TECHNICAL FIELD

The present invention generally relates to, but is not limited to, molding systems, and more specifically the present invention relates to, but is not limited to, (i) a mold-cooling device, (ii) a molding system having a mold-cooling device, (iii) a mold assembly having a mold-cooling device, (iv) a molded article, such as a preform, which is manufactured by a molding system in cooperation with a mold assembly and with a mold-cooling device, and (v) a method of a mold-cooling device, amongst other things.

### BACKGROUND

Page 453 of a technical-reference manual Plastics Mold Engineering (ISBN: 65-24910; Published: 1965) discloses illustration number FIG. 9.14 that shows a core cooling circuit with a spirally-shaped cooling circuit.

U.S. Pat. No. 5,443,381 (Inventor: Gellert, Jobst U.; Published: Aug. 22, 1995) discloses an injection molding gate and a cavity insert for multi-cavity molding that includes rib portions projecting in a cooling-fluid chamber to improve both cooling of plastic melt and structural strength of the cavity insert.

U.S. Pat. No. 5,599,567 (Inventor: Gellert, Jobst U.; Published: Feb. 4, 1997) discloses cooled thread split inserts for injection molding bottle preforms. Steel split inserts are adapted to form the threaded neck portion of a bottle preform when mounted in a mold, and the inserts have a cooling conduit extending around a cavity portion.

U.S. Reissued Pat. No. 38,396 (Inventor: Gellert, Jobst Ulrich; Published Jan 27, 2004) discloses pairs of thread split metal inserts (with internal conduits for a cooling fluid) for injection molding of a ring collar and a thread of a plastic-bottle preform. This patent is a reissue of U.S. Pat. No. 5,930,882.

U.S. Pat. No. 6,079,972 (Inventor: Gellert, Jobst Ulrich; Published: Jun. 27, 2000) discloses an injection molding apparatus that has an elongated cavity in a mold and a cooled mold core made of hollow elongated inner and outer parts with spiral grooves for carrying a cooling fluid.

U.S. Pat. No. 6,488,881 (Inventor: Gellert, Jobst Ulrich; Published: Dec. 3, 2002) discloses an injection-molding apparatus for molding beverage bottle preforms. The apparatus includes a cooling fluid flow channel extending between an inner and an outer portion of a cavity insert.

United States Patent Application No. 2005/0276879 (Inventor: Niewels, Joachim Johannes et al; Published Dec. 15, 2005) discloses an insert for cooling a neck ring of a molded preform. The insert includes a cooling circuit having an inlet portion for providing a fluid coolant to a divided channel that forms two channels extending in an opposite direction parallel with an inner surface of a neck ring half shell.

United States Patent Number 2005/0161860A1 (Inventor: Lausenhammer et al; Published: Jul. 28, 2005) discloses a cooling system for sleeves on a carrier plate used to cool plastic bottle preforms. The cooling system has principal supply lines which supply parallel distribution lines interrupted by plugs.

Canadian Patent Number 2,513,211 AA (Inventor: Lausenhammer et al; Published: Aug. 26, 2004) discloses a cooling system for multiple tools, especially for blow-molding preforms. The cooling system has a flow path arranged to cool tool parts partially in series.

U.S. Pat. No. 6,632,081 (Inventor: Cromwijk; Published: Oct. 14, 2003) discloses a mold-cooling assembly that includes an annular-channel system that surrounds a mold. The annular-channel system has a channel having: (i) an entrance for supplying a cooling medium to the interior of the channel, and (ii) a mold-facing outlet that directs the cooling medium along a tangential flow around the mold.

U.S. Pat. No. 6,802,705 (Inventor: Brand et al; published: Oct. 12, 2004) discloses a cooling apparatus, such as a cooling plate, for post-mold cooling of a molded article. The cooling apparatus includes a base with a distributor for providing a coolant to an insert that discharges the coolant to an exposed-outer surface of a molded article.

### SUMMARY

According to a first aspect of the present invention, there is provided a mold-cooling device, which includes a vortex-inducing cooling-fluid chamber.

According to a second aspect of the present invention, there is provided a molding system that has a mold-cooling device, which includes a vortex-inducing cooling-fluid chamber.

According to a third aspect of the present invention, there is provided a mold assembly that has a mold-cooling device, which includes a vortex-inducing cooling-fluid chamber.

According to a fourth aspect of the present invention, there is provided a molded article manufactured by a molding system in cooperation with a mold assembly and with a mold-cooling device, which includes a vortex-inducing cooling-fluid chamber.

According to a fifth aspect of the present invention, there is provided a method of mold-cooling device, which includes a vortex-inducing cooling-fluid chamber.

A technical effect, amongst others, of the aspects of the present invention is a cycle-time reduction of a molding system that uses a mold-cooling device to manufacture a molded article, such as a preform for example. By increasing the amount of heat removed from a freshly molded article (that is, increasing cooling of the molded article), the molded article may then be removed sooner (rather than later) from a mold assembly and thus this arrangement permits a reduction (advantageously) in the cycle time of the molding system.

### BRIEF DESCRIPTION OF THE DRAWINGS

A better understanding of the exemplary embodiments of the present invention (including alternatives and/or variations thereof) may be obtained with reference to the detailed description of the exemplary embodiments along with the following drawings, in which:

FIG. 1 is a schematic representation of a mold-cooling device according to a first exemplary embodiment;

FIG. 2 is a perspective view of the mold-cooling device of FIG. 1;

FIG. 3 is a perspective view and a top view of the mold-cooling device of FIG. 1;

FIG. 4 is a perspective view and a top view of variants of the mold-cooling device of FIG. 1;

FIG. 5 is a perspective view of variants of the mold-cooling device of FIG. 1;

FIG. 6 is a perspective view of a mold-cooling device according to a mold-cooling device according to a second exemplary embodiment (which is the preferred embodiment);

FIG. 7 is a close-up perspective view of the mold-cooling device of FIG. 6;

FIG. 8 is a top view of the mold-cooling devices of FIGS. 1 and 6; and

FIG. 9 is a perspective view of a mold-cooling device according to a third exemplary embodiment.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### DETAILED DESCRIPTION OF THE EXEMPLARY EMBODIMENTS

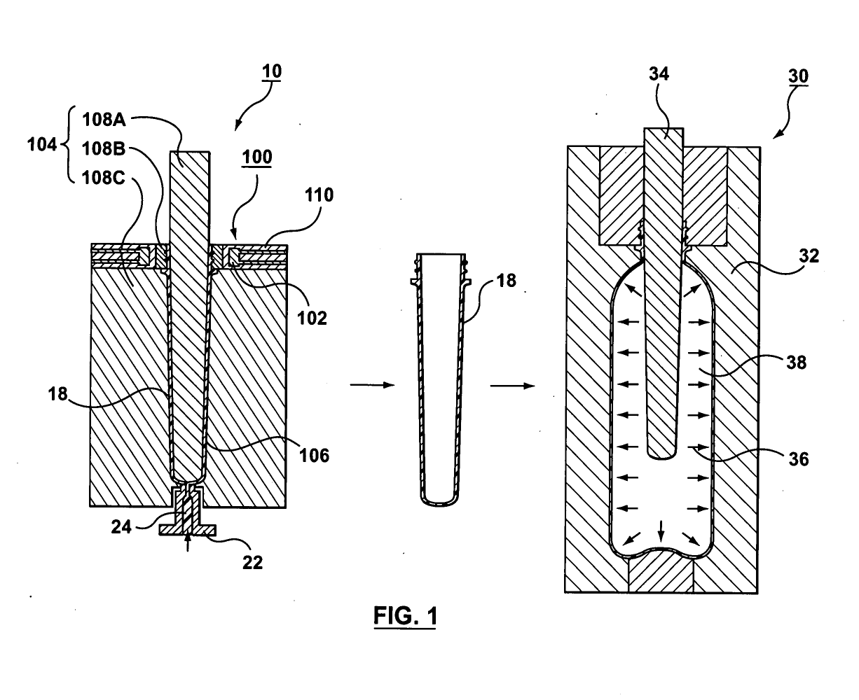

FIG. 1 is a schematic representation of a mold-cooling device 100 (hereafter referred to as “the device 100”) according to the first exemplary embodiment. The device 100 includes a vortex-inducing cooling-fluid chamber 102 (hereafter referred to as “the chamber 102”). The chamber 102 is positionable proximate to a mold assembly 104 so that the chamber 102 may increase or improve cooling of the mold assembly 104 at least in part. The chamber 102 (also called an atrium, a room or a container, etc) is any chamber that is connectable or is connected to other chambers or to passageways. The chamber 102 assists in the rotation of a portion of a cooling fluid so that the rotating cooling fluid forms a vortex. By being made to rotate in a vortex pattern, the cooling fluid has an opportunity to absorb additional heat from the mold assembly 104 before the molded article exits from the mold assembly 104. By having the cooling fluid rotate in the vortex pattern, an increased number of molecules of the cooling fluid are brought into contact with the wall of the chamber 102, and in this manner the molecules (of the cooling fluid) are used more efficiently for removing heat from the chamber 102 (that is, without having to increase the velocity of the cooling fluid to in order to have more molecules contact the chamber 102). Preferably, the cooling fluid 112 re-circulates within the chamber 102 at least in part so that the re-circulated cooling fluid has an opportunity to pick up (absorb) more heat from a mold 104, preferably before the re-circulated cooling fluid departs from the chamber 102.

Also, in this arrangement, a lower amount of cooling fluid may flow through the chamber 102. Preferably, not necessarily, (i) the cooling fluid rotates about a vortex axis at least 360 degrees within the chamber 102, and/or (ii) the chamber 102 permits the cooling fluid 112 (at least in part) to dwell locally within the chamber 102 for a predetermined amount of time, or the chamber 102 does not include a turbine rotor (or other mechanical rotating mechanism) that actively rotates the cooling fluid 112 within the chamber 102.

Generally, the mold assembly 104 is used to mold a molded article. The preform 18 is an example of a molded article. The preform 18 is an object that has been subjected to preliminary, usually incomplete shaping or molding, before undergoing complete or final processing. A molded article is (i) an object that does not require further molding or shaping (that is, it is a completed object), or (ii) an object that requires further molding or shaping.

A molding system 10 (partially depicted) cooperates with the mold assembly 104 to manufacture the preform 18 (preferably, to manufacture a plurality of preforms for each cycle of the molding system 10). The mold assembly 104 defines a molding surface 106, and includes a plurality of mold portions, such as: a core mold 108A, a neck mold 108B (alternatively called a collar mold) and a cavity mold 108C. Preferably, the chamber 102 is located proximate to the neck mold 108B, and the neck mold 108B is adapted to form a ring collar and a threaded neck portion of the preform 18. The neck mold 108B is separable so as to permit removal of the preform 18 from the mold assembly 104 once the preform 18 has been molded. A mold support 110 is configured to support: (i) the mold assembly 104 (and/or a part thereof), or (ii) the neck mold 108B more preferably.

The device 100 may be installed in the molding system 10 such as the HyPET™ System manufactured by Husky Injection Molding Systems Limited (Location: Bolton, Ontario, Canada; WWW-URL:www.husky.ca). The molding system 10 injects a molding material 24 via a nozzle 22 into a mold cavity defined by the mold assembly 104. Once the molding system 10 and the mold assembly 104 have cooperatively molded the preform 18, the mold assembly 104 is opened so that a preform-removal device (not depicted) may be used to transfer the preform 18 from the mold assembly 104 of the molding system 10 into a blow mold 32 of a blow molding system 30. After suitable temperature conditioning of the preform 18, an air line 34 is inserted into the cavity of the preform 18 and air pressure 36 is then introduced into the cavity of the preform 18. In response to becoming pressurized, the preform 18 is blown to conform to the blow mold 32, which then forms a completed bottle 38. Then the bottle 38 is removed from the blow mold 32, and the bottle 38 is filled with a beverage (for example).

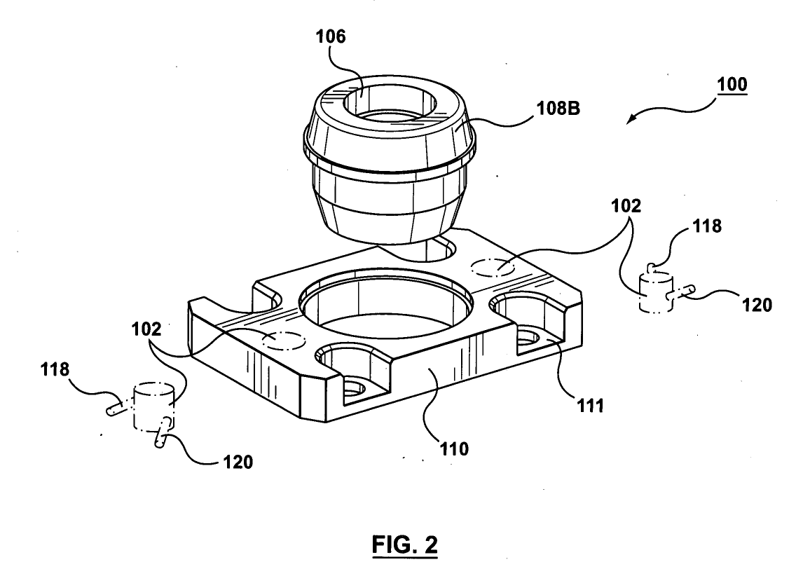

FIG. 2 is a perspective view of the device 100 of FIG. 1. Preferably, the chamber 102 is accommodated or housed by the mold support 110. According to variants, the mold assembly 104 accommodates or houses the chamber 102 (that is, the chamber 102 is accommodated by any of the mold portions 108A, 108B and 108C in any combination and permutation thereof). A cooling-fluid inlet 118 leads to the chamber 102, and a cooling-fluid outlet 120 leads away from the chamber 102. The mold support 110 includes mounting connections 111 that permit mounting the mold support 110 to the structure of the molding system 10. Preferably, the chamber 102 is housed or accommodated in the mold support 110; alternatively, the chamber 102 may be housed in the mold assembly 104, or the chamber 102 may be separate from the mold 104 and from the mold support 110 (such as a slide assembly for example).

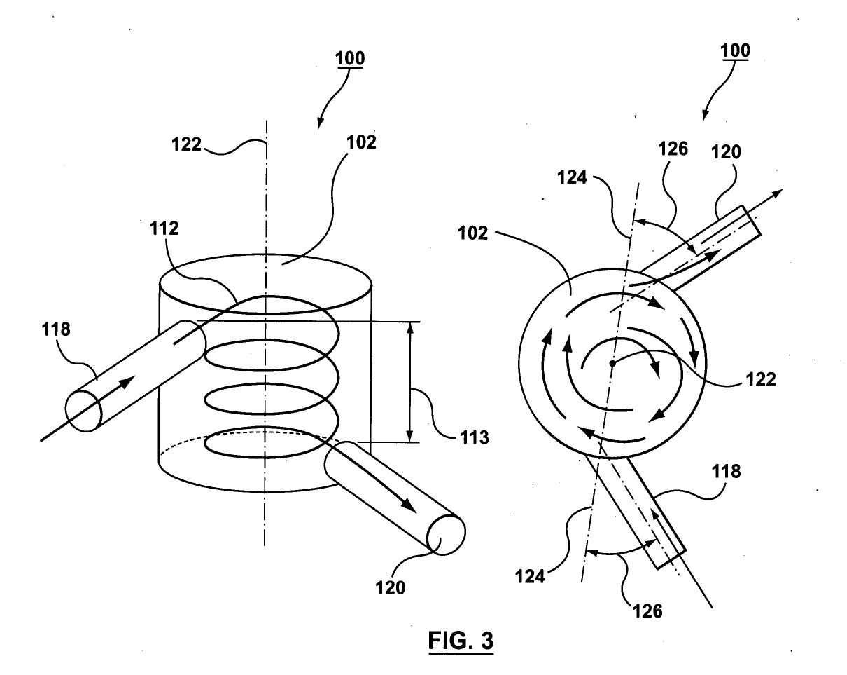

FIG. 3 is a perspective view and a top view of the device 100 of FIG. 1. The chamber 102 imparts a vortex effect (or a vortical motion) onto a cooling fluid 112 (such as water) that is delivered to the chamber 102. The purpose of the chamber 102 is to increase the amount or degree of cooling of the neck mold 108B. According to variants, the chamber 102 is used to increase cooling of the mold assembly 104 and/or any mold portion of the mold assembly 104. The chamber 102 permits a portion of a cooling fluid to rotate within the chamber 102 (at least in part) so that the cooling fluid has an opportunity to absorb additional heat from the preform 18 (that is, a molded article) before exiting the chamber 102. Vortical motion means a shape that resembles or is a vortex in form or motion; whirling; as, a vortical motion.

Equivalents to the vortex effect are: (i) a whirlpool, a maelstrom or a tourbillion, which is a circular current of fluid (relative to a central axis of rotation or a vortex axis) or a flow in a circular current of a fluid; (ii) a swirl, a whirl, a twirl or a spin, which is a shape of rotating fluid (relative to a central axis of rotation), or turn in a twisting or spinning motion of a fluid; and/or (iii) an eddy, which is a whirlpool of a current of a fluid that may double back on itself, or a flow in a circular current of a fluid. The chamber 102 imparts rotation to the cooling fluid 112 relative to a central axis of rotation. Preferably, the chamber 102 imparts rotation to at least a part of the cooling fluid 112 within the chamber 102. Preferably, the cooling-fluid inlet 118 is placed at an offset 113 from the cooling-fluid outlet 120 to improve the vortex effect imparted onto the cooling fluid 112.

According to a variant: the chamber 102 rotates the cooling fluid 112 non-circumferentially about a mold assembly 104. According to another variant: the chamber 102 rotates the cooling fluid 112 within a closed-cooling circuit (that is, the cooling fluid 112 is not released into the atmosphere, for example).

Within the chamber 102 is a vortex axis 122 (hereafter referred to as “the axis 122”) that the cooling fluid 112 rotates around. The axis 122 may be straight or may be curved. Preferably, the cooling-fluid inlet 118 and the cooling-fluid outlet 120 both enter the chamber 102 tangentially (or off-axis) at least in part relative to the axis 122 (that is, preferably, not in-line with the axis 122). According to a variant, the cooling-fluid inlet 118 enters the chamber 102 tangentially relative to the axis 122, and the cooling-fluid outlet 120 enters in-line with the axis 122. According to another variant, the cooling-fluid outlet 120 enters the chamber 102 tangentially relative to the axis 122, and cooling-fluid inlet 118 enters in-line with the axis 122. According to yet another variant, the cooling-fluid outlet 120 and cooling-fluid inlet 118 enter in-line with the axis 122. These variants permit controlling speed of the cooling fluid, the degree of vortex effect imparted to the cooling fluid, the degree of cooling performance of the chamber 102, the amount of pressure loss incurred by the chamber 102, the amount of flow of the cooling fluid, and/or the amount of turbulence imparted to the cooling fluid in the chamber 102.

Preferably, the cooling-fluid inlet 118 and the cooling-fluid outlet 120 extend along a radial direction 124 of the axis 122. Preferably, the cooling-fluid inlet 118 and the cooling-fluid outlet 120 extend along an angle 126 aligned obtuse relative to a radial direction 124 of the axis 122 (this arrangement improves the vortex effect imparted to the cooling fluid 112).

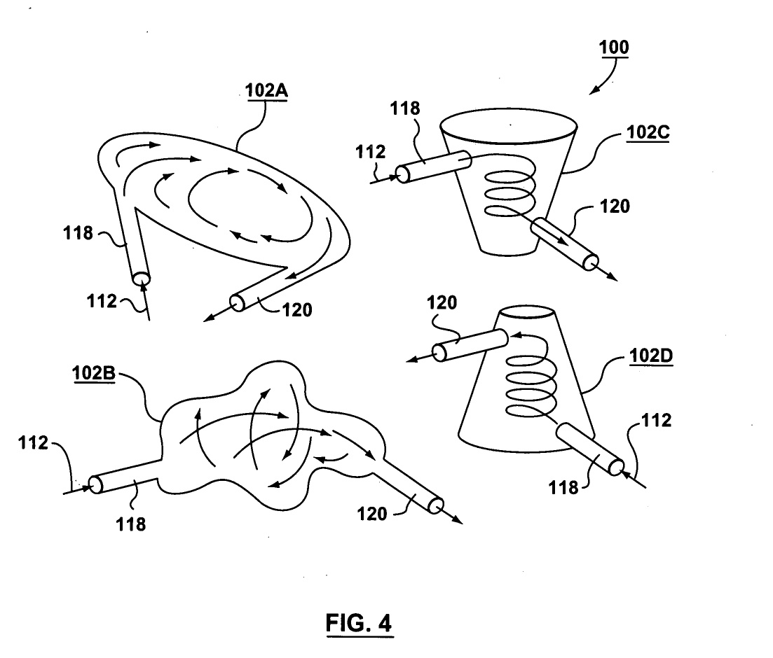

FIG. 4 is a perspective view and a top view of variants of the device 100 of FIG. 1. Depicted are variant chambers 102A, 102B, 102C and 102D of the chamber 102. The variant chamber 102A (top view) is elliptically shaped (that is, of, relating to, or having the shape of an ellipse, or containing or characterized by ellipsis). The variant chambers 102B, 102D (side views) are frustum shaped (that is, shaped to resemble a truncated cone or a pyramid, which is the part that is left when a cone or a pyramid is cut by a plane parallel to the base and the apical part is removed). The variant chamber 102B (top view) is randomly shaped (that is, having no specific pattern or shape, which helps to increase turbulence within the chamber 102B but permitting the cooling fluid 112 to continue rotating in the chamber 102 at least in part). Each variant chamber 102A, 102B, 102C 102D imparts a vortex effect onto at least a part of the cooling fluid 112 that is positioned within the chamber 102 for at least a duration of time that the cooling fluid 112 rotates within the chamber 102. The inlet 118 and the outlet 120 may be on the same plane or they may be on different planes.

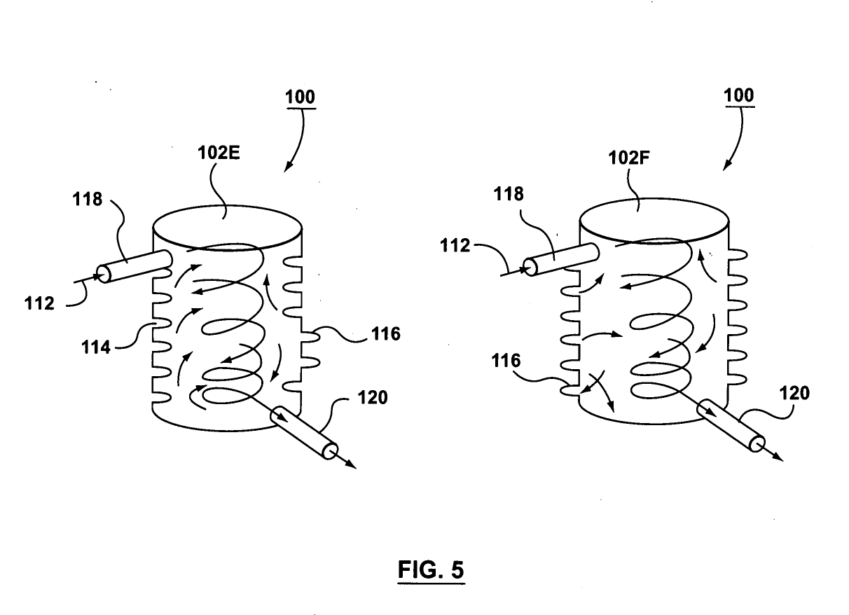

FIG. 5 is a perspective view of variants of the device 100 of FIG. 1. Additional variant chambers 102E, 102F are configured to induce additional turbulence into the cooling fluid 112. The manner in which the turbulence is induced is not relevant, and the following description indicates several approaches or alternatives that are suitable for inducing turbulence onto the cooling fluid that rotates in a vortex.

According to a first turbulence-inducing approach, a deflector 114 is disposed in the chamber 102. The deflector 114 increases turbulence within the chamber 102 by deflecting the cooling fluid 112 that is swirling within the chamber 102. The deflector 114 extends into the chamber 102 from a side wall of the chamber 102. The deflector 114 is stationary. According to a variation (not depicted), the deflector 114 includes a rotor device (such as an actuatably rotatable turbine) that actively churns the cooling fluid 112 as the cooling fluid rotates in the chamber 102) before the cooling fluid 112 exits from the chamber 102.

According to a second turbulence-inducing approach, a recess 116 (defined by the side wall of the chamber 102) is used, and the recess 116 is configured to increase turbulence within the chamber 102 by permitting the cooling fluid 112 to rotate and glance off the recess 116. The deflector 114 and the recess 116 may be used in combination or separately (or not at all).

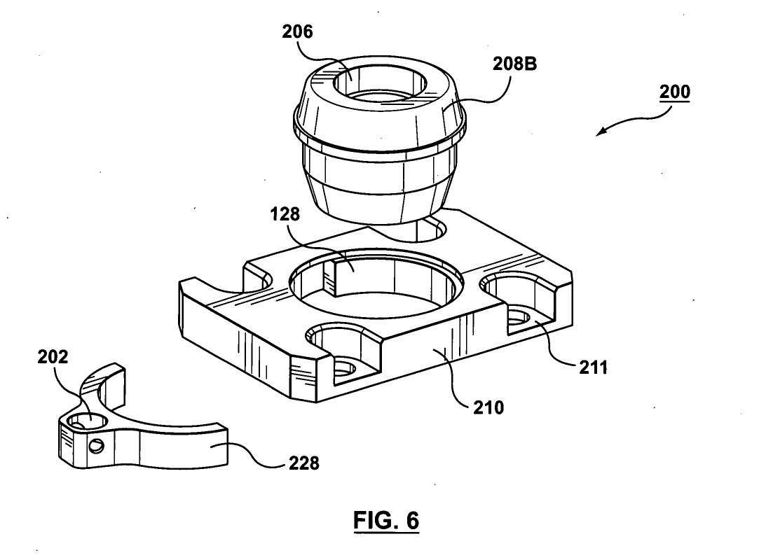

FIG. 6 is a perspective view of a mold-cooling device 200 (hereafter referred to as “the device 200”) according to the second exemplary embodiment. The device 200 includes a vortex-inducing cooling-fluid chamber 202 (hereafter referred to as “the chamber 202”). To facilitate an understanding of the second exemplary embodiment, elements of the second exemplary embodiment (that are similar to those of the first exemplary embodiment) are identified by reference numerals that use a two-hundred designation rather than using a one-hundred designation (as used in the first exemplary embodiment). For example, the chamber of the second exemplary embodiment is labeled 202 rather than being labeled 102, etc.

The chamber 202 is configured to cooperate with a mold support 210. The mold support 210 cooperates with an insert 228. The insert 228 accommodates or houses the chamber 202. The insert 228 fits between the neck mold 208B and the mold support 210. The insert 228 is formed to surround the neck mold 208B at least in part.

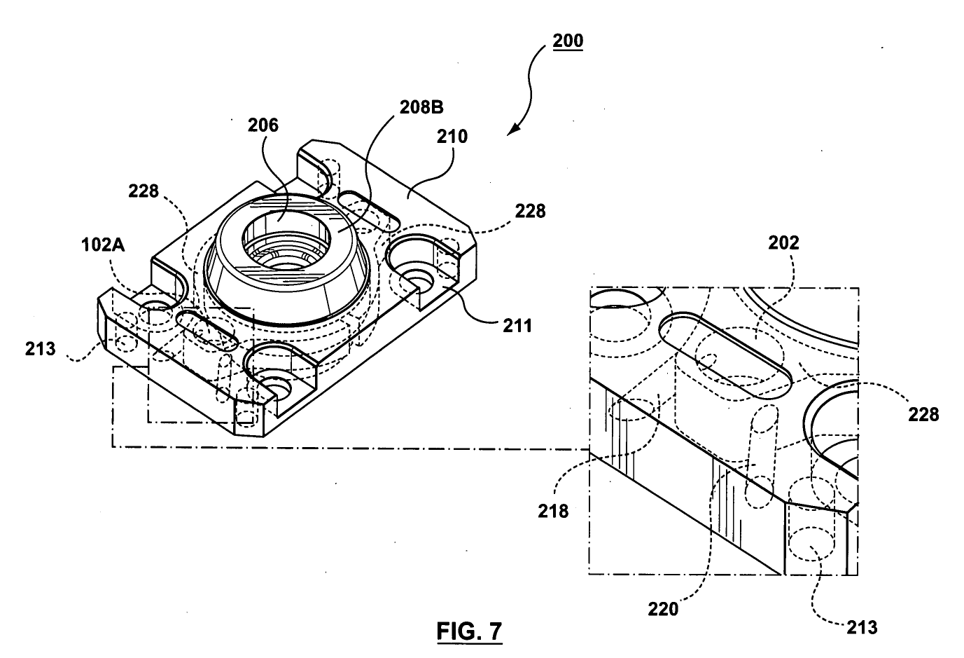

FIG. 7 is a close-up perspective view of the device 200 of FIG. 6. A connection 211 is used to connect the mold support 210 to structural member (not depicted) of the molding system 10. A dowel 213 may be used to locate the mold support 210 or to align the mold support 210 relative to the molding system 10. Preferably, the chamber 102, 202 includes a material (such as copper or silver or equivalent: either metallic material or non-metallic material) that is multi-directionally heat conductive. One approach (other approaches are possible) is to assemble the components as follows: once the neck mold 108B, 208B, the chamber 102, 202 and the mold support 110, 210 (respectively) are assembled, the assembly of parts is braised so as to weld the parts together, and then the assembly of parts is cut in half (as known to those skilled in the art) so that the neck mold 108B, 208B may be separated after the preform 18 has been molded, so that the preform 18 may be easily removed from the separated neck mold 108B, 208B.

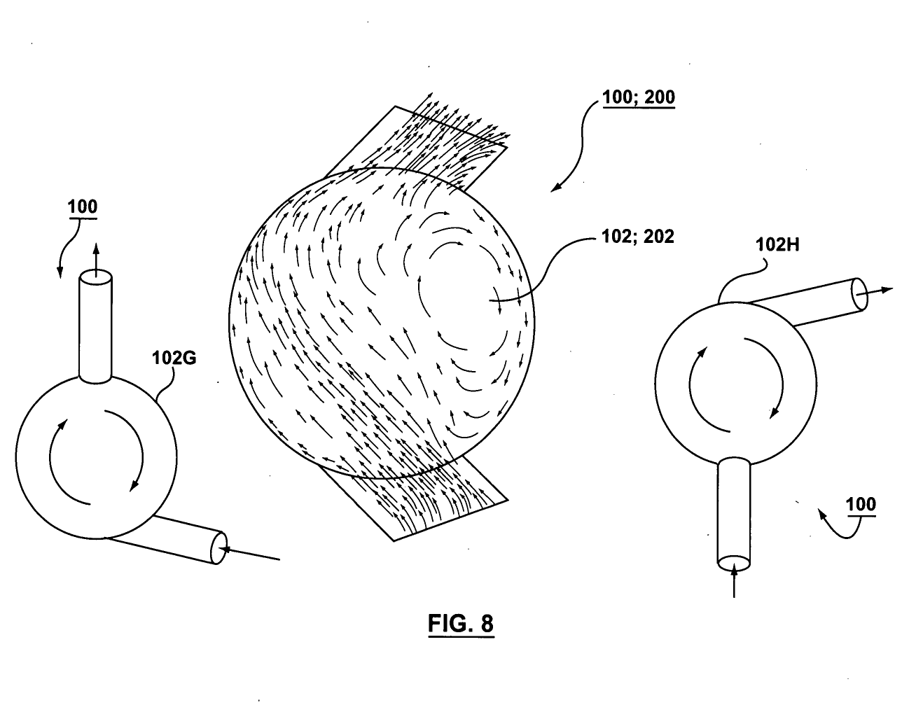

FIG. 8 is a top view of the device 100 of FIG. 1 and of the device 200 of FIG. 6. FIG. 8 is a depiction of an instant in time of a simulation of a vortex effect imparted by the chamber 102 or the chamber 202 onto a cooling fluid that is injected into the chamber 102 or the chamber 202.

The chamber 102, 202 may be supplied or sold in the following arrangements: (i) a mold-cooling device 100, 200 (that is by itself), (ii) a molding system 10 having a mold-cooling device 100, 200, (iii) a mold assembly 104, 204 having a mold-cooling device 100, 200 (respectively), (iv) a molded article, such as a preform 18, which is manufactured by a molding system 10 in cooperation with a mold assembly 104, 204 and with a mold-cooling device 100, 200 (respectively), and (v) a method of a mold-cooling device 100, 200.

Additional variant chambers 102G, 102H are configured to permit a cooling fluid to enter and exit the chamber 102 along different approaches. The variant chamber 102G permits the cooling fluid to exit in a direction that is perpendicular to a vortex axis while permitting the cooling fluid to enter tangentially to the vortex axis. The variant chamber 102H permits the cooling fluid to enter in a direction that is perpendicular to a vortex axis while permitting the cooling fluid to exit tangentially to the vortex axis.

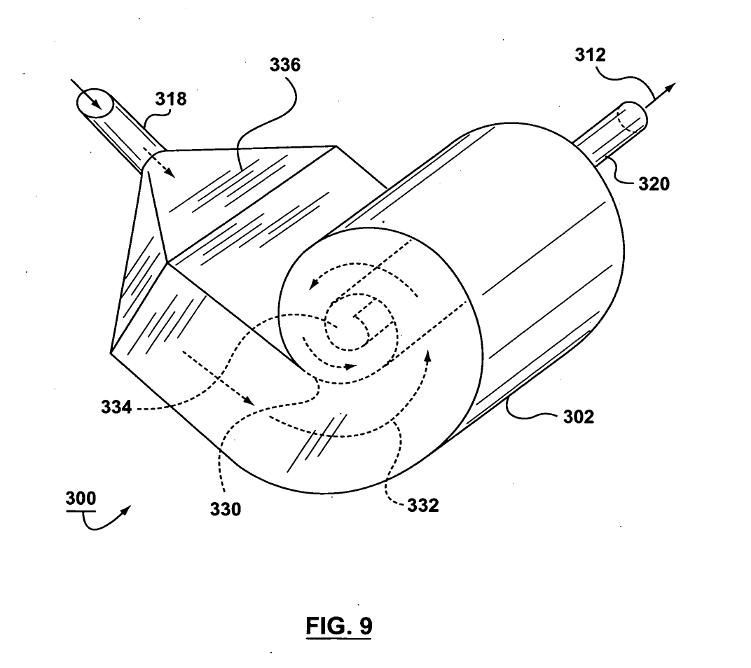

FIG. 9 is a perspective view of a mold-cooling device 300 (hereafter referred to as “the device 300”) according to the third exemplary embodiment. The device 300 includes a vortex-inducing cooling-fluid chamber 302 (hereafter referred to as “the chamber 302”). To facilitate an understanding of the third exemplary embodiment, elements of the third exemplary embodiment (that are similar to those of the first exemplary embodiment) are identified by reference numerals that use a three-hundred designation rather than using a one-hundred designation (as used in the first exemplary embodiment). For example, the chamber of the third exemplary embodiment is labeled 302 rather than being labeled 102, etc.

The chamber 302 includes an internal wall 330 that is curved at least in part. Preferably, the wall 330 includes a material that promotes high heat conductivity (such as cooper and the like). An inlet 318 is attached to a plenum 336 that then leads into the side wall of the chamber 302, so that a cooling fluid 312 exits the inlet 318 as a tube of fluid may be transformed by the plenum 336 and enter the interior of the chamber 302 as a flowing sheet of fluid, that then travels along a spiral path 332 within the chamber 302. The plenum 336 is used for reshaping the flow of a cooling fluid. The internal wall 330 (which is similar to a deflector) keeps the flowing sheet of cooling fluid spinning along the spiral path 332 to ward a vortex axis 334 that extends along the chamber 302. An outlet 320 exists along the vortex axis 334. According to a variant (not depicted), the internal wall 330 is aligned straight (that is, not smoothly curved) or aligned in straight-lined segments. Preferably, the outlet 320 exists along the vortex axis 334. According to a variant, the outlet 320 exists off axis from the vortex axis 320.

According to an alternative, the functions of the inlet 318 and the outlet 320 are reversed so that a cooling fluid enters via the outlet 320 (so that the item 320 acts as the inlet) while the cooling fluid exits via the inlet 318 (so that item 318 acts as the outlet). According to another alternative, there are two outlets that enter the chamber 302; the outlet 320 brings the cooling fluid out as depicted and another outlet (not depicted) is placed or located on an opposite side of the chamber 302 relative to the outlet 320.

The description of the exemplary embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following claims:

What is claimed is:

1. A mold-cooling device, comprising:
a vortex-inducing cooling-fluid chamber.

2. The mold-cooling device of claim 1, wherein the vortex-inducing cooling-fluid chamber re-circulates a cooling fluid in part so that re-circulated cooling fluid absorbs more heat from a mold assembly.

3. The mold-cooling device of claim 1, wherein the vortex-inducing cooling-fluid chamber rotates a cooling fluid within a closed-cooling circuit.

4. The mold-cooling device of claim 1, wherein the vortex-inducing cooling-fluid chamber rotates a cooling fluid non-circumferentially about a mold assembly.

5. The mold-cooling device of claim 1, wherein the vortex-inducing cooling-fluid chamber is configured to cooperate with a mold assembly.

6. The mold-cooling device of claim 1, wherein the vortex-inducing cooling-fluid chamber is configured to cooperate with a mold assembly, the mold assembly including mold portions defining a molding surface.

7. The mold-cooling device of claim 1, wherein the vortex-inducing cooling-fluid chamber is configured to cooperate with a mold assembly, the mold assembly including a mold support configured to support the mold assembly.

8. The mold-cooling device of claim 1, wherein the vortex-inducing cooling-fluid chamber is accommodated by a mold assembly and by a mold support.

9. The mold-cooling device of claim 1, wherein the vortex-inducing cooling-fluid chamber is accommodated by a mold assembly.

10. The mold-cooling device of claim 1, wherein the vortex-inducing cooling-fluid chamber accommodated by a mold support.

11. The mold-cooling device of claim 1, wherein the vortex-inducing cooling-fluid chamber imparts a vortex effect onto a cooling fluid positionable in the vortex-inducing cooling-fluid chamber.

12. The mold-cooling device of claim 1, wherein the vortex-inducing cooling-fluid chamber is configured to rotate at least a portion of a cooling fluid.

13. The mold-cooling device of claim 1, wherein the vortex-inducing cooling-fluid chamber is configured to rotate at least a portion of a cooling fluid at least 360 degrees within the vortex-inducing cooling-fluid chamber.

14. The mold-cooling device of claim 1, wherein the vortex-inducing cooling-fluid chamber is configured to induce turbulence in a cooling fluid disposed in the vortex-inducing cooling-fluid chamber.

15. The mold-cooling device of claim 1, wherein the vortex-inducing cooling-fluid chamber is any one of cylindrically shaped, randomly shaped, frustum shaped, elliptically shaped and any combination and permutation thereof.

16. The mold-cooling device of claim 1, further comprising:
a deflector disposed in the vortex-inducing cooling-fluid chamber, the deflector increases turbulence within the vortex-inducing cooling-fluid chamber.

17. The mold-cooling device of claim 1, further comprising:
a deflector disposed in the vortex-inducing cooling-fluid chamber, the deflector increases turbulence within the vortex-inducing cooling-fluid chamber, the deflector extending from the mold assembly into the vortex-inducing cooling-fluid chamber.

18. The mold-cooling device of claim 1, further comprising:
a deflector disposed in the vortex-inducing cooling-fluid chamber, the deflector increases turbulence within the vortex-inducing cooling-fluid chamber, the deflector being movable.

19. The mold-cooling device of claim 1, wherein the vortex-inducing cooling-fluid chamber defines a recess, the recess is configured to increase turbulence within the vortex-inducing cooling-fluid chamber.

20. The mold-cooling device of claim 1, wherein the vortex-inducing cooling-fluid chamber includes:
a cooling-fluid inlet connectable to the vortex-inducing cooling-fluid chamber; and
a cooling-fluid outlet connectable to the vortex-inducing cooling-fluid chamber.

21. The mold-cooling device of claim 1, wherein the vortex-inducing cooling-fluid chamber includes:
a cooling-fluid inlet connectable to the vortex-inducing cooling-fluid chamber; and
a cooling-fluid outlet connectable to the vortex-inducing cooling-fluid chamber, the cooling fluid rotates about a vortex axis, any one of the cooling-fluid inlet and the cooling-fluid outlet in any combination and permutation extends tangentially relative to the vortex axis.

22. The mold-cooling device of claim 1, wherein the vortex-inducing cooling-fluid chamber is configured to cooperate with a mold support, the mold support cooperates with an insert, the insert accommodating the vortex-inducing cooling-fluid chamber.

23. The mold-cooling device of claim 1, wherein the vortex-inducing cooling-fluid chamber includes an internal wall.

24. The mold-cooling device of claim 1, wherein the vortex-inducing cooling-fluid chamber includes an internal wall that is shaped to form a spiral path.

25. The mold-cooling device of claim 1, wherein the vortex-inducing cooling-fluid chamber includes a plenum.

26. The mold-cooling device of claim 1, wherein the vortex-inducing cooling-fluid chamber is included with a molding system.

27. A molded article manufactured by a molding system in cooperation with a mold assembly and with the mold-cooling device of any one of claims 1 to 24.

28. A method, comprising:
imparting a vortex onto a cooling fluid of a mold-cooling device.

29. The method of claim 28, further comprising:
rotating the cooling fluid at least 360 degrees.

30. The method of claim 28, further comprising:
inducing turbulence in the cooling fluid disposed in a vortex-inducing cooling-fluid chamber of a mold-cooling device.

31. The method of claim 28, further comprising:
deflecting the cooling-fluid.

32. The method of claim 28, further comprising:
using a vortex-inducing cooling-fluid chamber to impart the vortex onto a cooling fluid.

33. The method of claim 32, further comprising:
inducing turbulence in the cooling fluid disposed in the vortex-inducing cooling-fluid chamber.

34. The method of claim 32, further comprising:
including a cooling-fluid inlet leading to the vortex-inducing cooling-fluid chamber; and
including a cooling-fluid outlet leading away from the vortex-inducing cooling-fluid chamber.
